(19) United States
(12) Patent Application Publication
(10) Pub. No.: US 2024/0245032 A1
(43) Pub. Date: Jul. 25, 2024

(54) PET BEDS AND COMPONENTS THEREOF

(71) Applicant: Worldwise, Inc., Novato, CA (US)

(72) Inventors: Brooke Rogers, San Rafael, CA (US); Lyle Koenig, San Francisco, CA (US); Ingrid VonderWische, Lombard, IL (US)

(21) Appl. No.: 18/100,861

(22) Filed: Jan. 24, 2023

(51) Int. Cl. A01K 1/035; B68G 7/06

(52) U.S. Cl. CPC A01K 1/0353; B68G 7/06

(57) ABSTRACT

A pet bed includes an exterior cover and an interior wall. The exterior cover has an interior surface that defines an interior of the pet bed, and the exterior cover has an upper portion and a lower portion. The interior wall is connected to both the upper and lower portions of the exterior cover. The interior wall separates the interior of the pet bed into a first filling chamber and a second filling chamber. The interior wall is configured to prevent a first portion of filling material disposed in the first filling chamber from moving into the second filling chamber, and the interior wall is configured to prevent a second portion of filling material disposed in the second filling chamber from moving into the first filling chamber.

### TECHNICAL FIELD

The present invention relates generally to pet beds and, more specifically, to pet beds having one or more interior walls for separating an interior of the pet bed into two or more filling chambers.

### BACKGROUND

There are many pet beds available to consumers having a variety of sizes and shapes. Pet beds typically include stuffing or filling that is packed within a cover or liner such that adequate support is provided that allows for the pet (e.g., dogs, cats, etc.) to lounge or sleep. Oftentimes, pets develop a strong affinity for their beds and seek them out as a safe haven for promoting rest and relaxation.

### SUMMARY

An example of a pet bed includes an exterior cover and an interior wall. The exterior cover has an interior surface that defines an interior of the pet bed, and the exterior cover has an upper portion and a lower portion. The interior wall is connected to both the upper portion and the lower portion of the exterior cover and extends along a length of the exterior cover, where the interior wall is disposed in the interior of the pet bed. The interior wall separates the interior of the pet bed into a first filling chamber and a second filling chamber. The interior wall is configured to prevent a first portion of filling material disposed in the first filling chamber from moving into the second filling chamber when a pet is providing a force to the pet bed, and the interior wall is configured to prevent a second portion of filling material disposed in the second filling chamber from moving into the first filling chamber when the pet is providing a force to the pet bed.

An example of a method of manufacturing a pet bed includes providing an exterior cover and an interior wall. The exterior cover has an upper portion and a lower portion, and the interior wall has a top portion and a bottom portion. The method further includes connecting the top portion of the interior wall to the upper portion of the exterior cover and connecting the bottom portion of the interior wall to the lower portion of the exterior cover. The interior wall separates the interior of the pet bed into a first filling chamber and a second filling chamber.

### BRIEF DESCRIPTION OF THE DRAWINGS

FIG. 1 is a schematic view of an example pet bed;

FIG. 2 is a cross-sectional schematic view of the pet bed of FIG. 1 taken along the line 2-2 shown in FIG. 1, where filling material is positioned in the interior of the pet bed;

FIG. 3 is a cross-sectional schematic view of the pet bed of FIG. 1 taken along the line 3-3 shown in FIG. 1;

FIG. 4 is a schematic view of another example pet bed;

FIG. 5 is a cross-sectional schematic view of the pet bed of FIG. 4 taken along the line 5-5 shown in FIG. 4;

FIG. 6 is a perspective view of another example pet bed;

FIG. 7 is side view of the pet bed of FIG. 6;

FIG. 8 is a cross-sectional view of the pet bed of FIG. 6 taken along the line 8-8 shown in FIG. 7;

FIG. 9 is a front view of the pet bed of FIG. 6;

FIG. 10 is a cross-sectional view of the pet bed of FIG. 6 taken along the line 10-10 shown in FIG. 9;

FIG. 11 is a top view of the pet bed of FIG. 6;

FIG. 12 is a bottom view of the pet bed of FIG. 6; and

FIG. 13 illustrates an example of a method for manufacturing a pet bed.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features and components of one exemplary embodiment may be incorporated into the other exemplary embodiments. Inventions within the scope of this application may include additional features, or may have less features, than those shown in, and described in connection with, the exemplary embodiments.

As described herein, the terms “substantially” and “about” are defined as at least close to (and includes) a given value or state (preferably within 10% of, more preferably within 1% of, and most preferably within 0.1% of a given value or state).

Some of the pet beds described herein include an exterior cover having one or more interior walls that separate an interior of the exterior cover into two or more filling chambers for receiving a filing material. The pet beds described herein are advantageous because they allow for a pet bed that does not include an internal liner. That is, the exterior cover with the internal wall(s) allow for filling material to be disposed directly into the exterior cover, rather than the filling material being disposed in a liner that is to be positioned within the external cover. The internal wall(s) prevent filling material from moving into other filling chambers within the interior of the pet bed to prevent the pet bed from becoming uneven as a pet is using the pet bed. The internal wall(s) can further be configured to provide stability to the pet beds and provide for a desired loft or height of the pet bed.

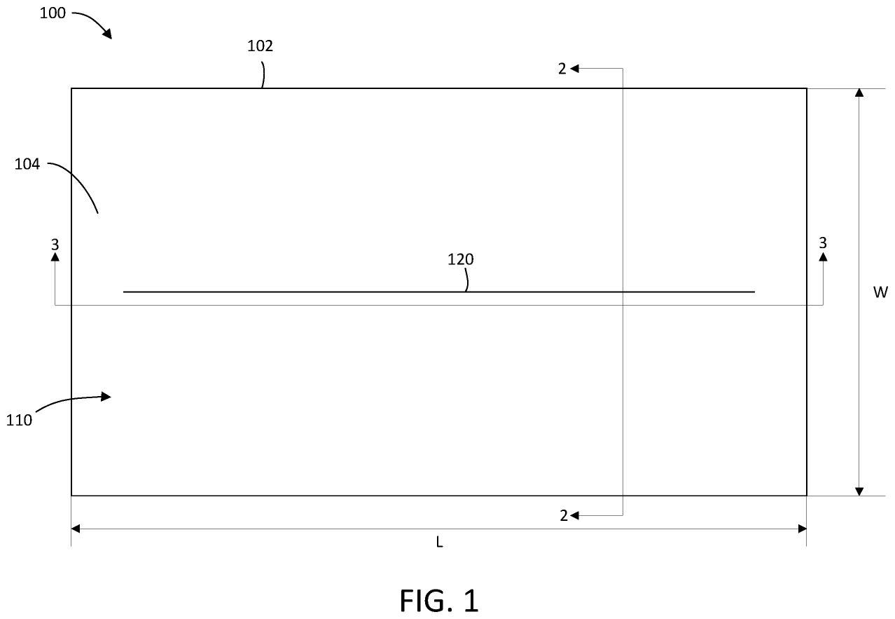

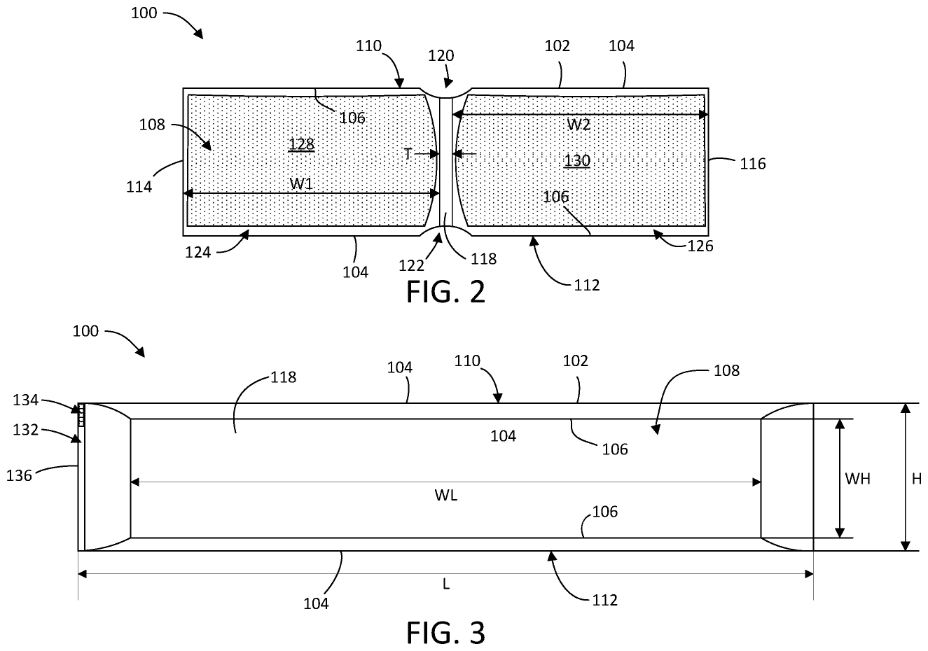

FIGS. 1-3 illustrate an example of a pet bed 100 that include an exterior cover 102 having an exterior surface 104 for being directly engaged by a pet. Referring to FIGS. 2 and 3, the exterior cover 102 further has an interior surface 106 that defines an interior 108 of the pet bed 100. The exterior cover 102 can have an upper portion 110 and a lower portion 112. In the illustrated example, the exterior cover 102 is gusseted such that side surfaces 114, 116 are connected to and extend between the upper portion 110 and the lower portion 112. In other examples, the upper and lower portions 110, 112 can be directly connected (e.g., by a sewn connection, by an adhesive connection, by the upper and lower portions 110, 112 being integral to each other, etc).

The exterior cover 102 can have a length L (FIGS. 1 and 3) that is between about 10 inches and about 100 inches (such as between about 20 inches and about 80 inches, such as between about 20 inches and about 60 inches, such as between about 20 inches and about 50 inches, such as between about 30 inches and about 40 inches, such as about 36 inches), and the exterior cover 102 can have a width W that is between about 10 inches and about 100 inches (such as between about 10 inches and about 80 inches, such as between about 10 inches and about 60 inches, such as between about 20 inches and about 50 inches, such as between about 20 inches and about 30 inches, such as about 27 inches). The exterior cover 102 can be made of, for example, polyester, cotton, rayon, polypropylene, taffeta, or any other suitable material. In some examples, the top portion 110 of the exterior cover 102 is made of a first material and the lower portion 112 of the exterior cover 102 is made from a second material that is different from the first material, where the first and second materials can be any of the materials listed in the present application for the exterior cover 102 or any other suitable material. While the illustrated example shows the pet bed 100 having a rectangular shape, it should be understood that the pet bed 100 can have any other suitable type of shape for a pet bed.

Referring to FIGS. 2 and 3, the pet bed 100 further includes an interior wall 118 that is connected to the upper and lower portions 110, 112 of the exterior cover 102. The interior wall 118 can be fixedly connected to the upper and lower portions 110, 112, such as, for example, by a sewn connection, an adhesive connection, or any other suitable type of fixed connection. In some examples, the interior wall 118 can be removably connected to the upper and lower portions 110, 112, such as, for example, by a buttoned connection, a snap fit connection, any other male/female type connection, a hook and loop connection, or any other type of removable connection. In some instances, the interior wall 118 can be fixedly connected to one of the upper and lower portions 110, 112 and removably connected to the other of the upper and lower portions 110, 112.

Referring to FIG. 3, the interior wall 118 can have a wall length WL of between about 8 inches and about 100 inches, such as between about 10 inches and about 90 inches, such as between about 15 inches and about 75 inches, such as between about 20 inches and about 60 inches, such as between about 20 inches and about 50 inches, such as between about 20 inches and about 40 inches, such as about 30 inches. In certain examples, the wall length WL of the interior wall 118 can be 50% or greater of the length L of the exterior cover 102, such as 60% or greater, 75% or greater, 80% or greater, 83% or greater, 90% or greater, 95% or greater, 98% or greater, or 99% or greater. In some instances, the length L of the exterior cover 102 can be substantially equal to the wall length WL of the interior wall 118. While the illustrated example shows the interior wall 118 being a single member that extends the wall length WL, in other examples, the interior wall 118 can include two or more members that combine to extend the wall length WL.

Still referring to FIG. 3, the pet bed 100 can have a largest height H of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. The interior wall 118 can have a wall height WH of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. In certain examples, the wall height WH of the interior wall 118 can be 50% or greater of the height H of the pet bed 100, such as 60% or greater, 75% or greater, 90% or greater, 95% or greater, 98% or greater, or 99% or greater. In some instances, the height H of the pet bed 100 can be substantially equal to the wall height WH of the interior wall 118. Referring to FIGS. 1 and 2, in some instances (e.g., such as when the wall height WH is less than the height H), the connection between the interior wall 118 (FIGS. 2-3) and the upper portion 110 of the exterior cover 102 can cause a groove or crease 120 in the upper portion 110 of the exterior cover 102. Referring to FIG. 2, the connection between the interior wall and the lower portion 112 of the exterior cover can cause a groove or crease 122 in the lower portion 112 of the exterior cover 102. The positioning of the interior wall 118 in the interior of the pet bed 100 can stabilize the pet bed 100 and cause the pet bed 100 to have a desired height.

Still referring to FIG. 2, the interior wall 118 can separate the interior 108 of the pet bed 100 into a first filling chamber 124 and a second filling chamber 126, where first filling material 128 can be disposed in the first filling chamber 124 and second filling material 130 can be disposed in the second filling chamber 126. The first and second filling material 128, 130 can be, for example, fiberfill, foam, spunbond fiber, cotton shoddy, hemp, or any other suitable type of filling material for a pet bed. In some instances, the filling material 128, 130 can include deodorizers and/or attractants, including, but not limited to Zeolite. The filling material 128, 130 can be configured to provide any suitable hardness or firmness to the pet bed 100, where the type of filling material being used can affect the hardness or firmness of the pet bed 100. In some examples, the filling material 128 in the first chamber 124 can be different than the filling material 130 in the second chamber 126 such that different portions of the pet bed 100 can have a different hardness or firmness. The first filling chamber 124 can have a width W1 of between about 5 inches and about 50 inches (such as between about 5 inches and about 40 inches, such as between about 5 inches and about 25 inches, such as between about 5 inches and about 20 inches, such as between about 10 inches and about 15 inches, such as about 13.5 inches), and the second filling chamber 126 can have a width W2 of between about 5 inches and about 50 inches (such as between about 5 inches and about 40 inches, such as between about 5 inches and about 25 inches, such as between about 5 inches and about 20 inches, such as between about 10 inches and about 15 inches, such as about 13.5 inches). In some instances, the width W1 and the width W2 are substantially equal. In other examples, the width W1 and the width W2 can be different.

The interior wall 118 is configured to prevent the first filling material 128 from moving into the second filling chamber 130 and to prevent the second filling material 130 from moving into the first filling chamber 128. This is advantageous because it prevents the pet bed 100 from becoming uneven due to movement of the filling material 128, 130 into the other filling chambers 124, 126. That is, with typical pet beds, a pet may be situated on one side of the pet bed and provide a force to the pet bed that causes the filling material on that side of the pet bed to move to the other side of the pet bed such that the pet bed is uneven. In these situations, the pet bed may remain uneven when the pet is no longer using the pet bed. However, the interior wall 118 is configured to prevent this type of movement of the filling material, which prevents the pet bed 100 from becoming uneven. The interior wall 118 can have a thickness T of between about 0.2 mm and about 1 mm. The interior wall 118 can be made of, for example, polyester, cotton, rayon, polypropylene, taffeta, any combination thereof, or any other suitable material.

Referring to FIG. 3, in various examples, the exterior cover 102 can include an opening 132 that is movable between an open position and a closed position. In the illustrated example, the opening 132 is shown in the closed position. The opening 132 allows a user to access the interior 108 of the pet bed 100 such that a user can insert filling material into the various filling chambers 124, 126 (FIG. 2) of the exterior cover 102, or such that a user can remove and replace filling material in the interior 108 of the pet bed 100. In instances where the interior wall 118 is removably connected to the exterior cover 102, the user can also access the interior 108 to remove the interior wall 118 such that a user can clean the exterior cover 102, or such that the user can replace the interior wall 118 with a new interior wall. The pet bed 100 can be placed into condition for use by a pet by a user moving the opening 132 to the closed position with filling material and the interior wall 118 within the interior 108 of the pet bed 100. The pet bed 100 can include a fastener 134 (e.g., a zip fastener, button(s), snap fasteners, hook and loop fasteners, etc.) that allows for a user to move the opening 132 between the open and closed positions. In the illustrated example, the opening 132 and fastener 134 is shown on a front face 136 of the exterior cover 102. However, it should be understood that the opening 132 and fastener 134 can be positioned in any suitable location on the exterior cover 102 that allows a user to access the first and second filling chambers 124, 126 on the interior 108 of the pet bed 100.

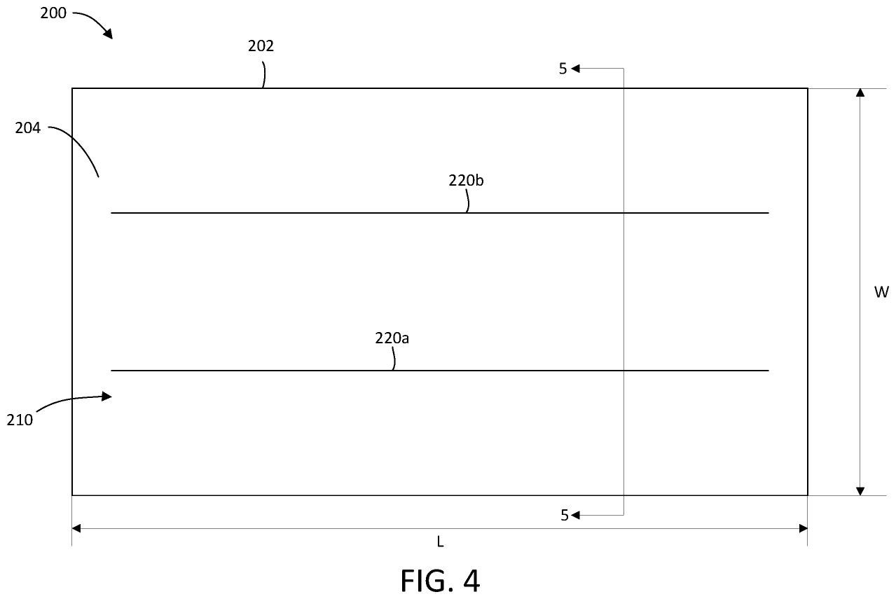

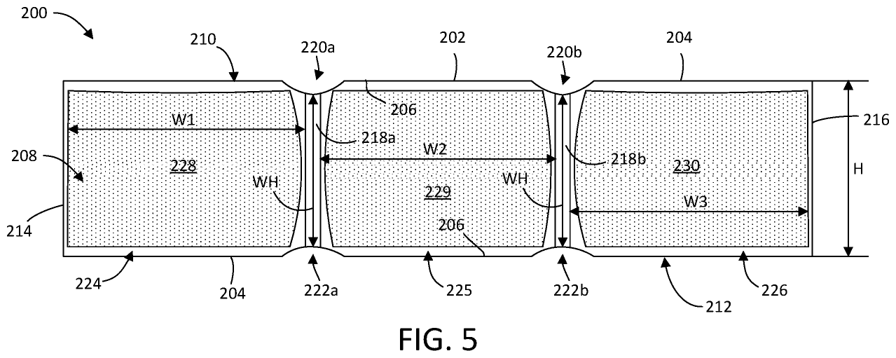

FIGS. 4 and 5 illustrate an example of a pet bed 200 that is similar to the pet bed 100 shown in FIGS. 1-3, except that the pet bed 200 includes two interior walls 218a, 218b (FIG. 5) that separate an interior 208 of the pet bed 200 into three filling chambers 224-226. The pet bed 200 includes an exterior cover 202 having an exterior surface 204 for being directly engaged by a pet. Referring to FIG. 5, the exterior cover 202 further has an interior surface 206 that defines an interior 208 of the pet bed 200. The exterior cover 202 can have an upper portion 210 and a lower portion 212. In the illustrated example, the exterior cover 202 is gusseted such that side surfaces 214, 216 are connected to and extend between the upper portion 210 and the lower portion 212. In other examples, the upper and lower portions 210, 212 can be directly connected (e.g., by a sewn connection, by an adhesive connection, by the upper and lower portions 210, 212 being integral to each other, etc).

The exterior cover 202 can have a length L (FIG. 4) that is between about 10 inches and about 100 inches (such as between about 20 inches and about 80 inches, such as between about 20 inches and about 60 inches, such as between about 20 inches and about 50 inches, such as between about 30 inches and about 40 inches, such as about 36 inches), and the exterior cover 202 can have a width W (FIG. 4) that is between about 10 inches and about 100 inches (such as between about 10 inches and about 80 inches, such as between about 10 inches and about 60 inches, such as between about 20 inches and about 50 inches, such as between about 20 inches and about 30 inches, such as about 27 inches). The exterior cover 202 can be made of, for example, polyester, cotton, rayon, polypropylene, taffeta, or any other suitable material. While the illustrated example shows the pet bed 200 having a rectangular shape, it should be understood that the pet bed 200 can have any other suitable type of shape for a pet bed. In some examples, the top portion 210 of the exterior cover 202 is made of a first material and the lower portion 212 of the exterior cover 202 is made from a second material that is different from the first material, where the first and second materials can be any of the materials listed in the present application for the exterior cover 202 or any other suitable material.

Referring to FIG. 5, the pet bed 100 further includes interior walls 218a, 218b that are connected to the upper and lower portions 210, 212 of the exterior cover 202. The interior walls 218a, 218b can be fixedly connected to the upper and lower portions 210, 212, such as, for example, by a sewn connection, an adhesive connection, or any other suitable type of fixed connection. In some examples, the interior walls 218a, 218b can be removably connected to the upper and lower portions 210, 212, such as, for example, by a buttoned connection, a snap fit connection, any other male/female type connection, a hook and loop connection, or any other type of removable connection. In some instances, the interior walls 218a, 218b can be fixedly connected to one of the upper and lower portions 210, 212 and removably connected to the other of the upper and lower portions 210, 212.

Each of the interior walls 218a, 218b can have a wall length (not shown—e.g., similar to the wall length WL shown in FIG. 3 for pet bed 100) of between about 8 inches and about 100 inches, such as between about 10 inches and about 90 inches, such as between about 15 inches and about 75 inches, such as between about 20 inches and about 60 inches, such as between about 20 inches and about 50 inches, such as between about 20 inches and about 40 inches, such as about 30 inches. In certain examples, the wall length of each of the interior walls 218a, 218b can be 50% or greater of the length L of the exterior cover 202, such as 60% or greater, 75% or greater, 80% or greater, 83% or greater, 90% or greater, 95% or greater, 98% or greater, or 99% or greater. In some instances, the length L of the exterior cover 202 can be substantially equal to the wall length of each of the interior walls 218a, 218b. In various instances, the wall length of a first interior wall 218a is substantially equal to the wall length of the other interior wall 218b. In other examples, the wall lengths of the interior walls 218a, 218b can be different. While the illustrated example shows each of the interior walls 218a, 218b being a single member that extends the wall length WL, in other examples, each of the interior walls 218a, 218b can include two or more members that combine to extend the wall length WL.

Referring to FIG. 5, the pet bed 200 can have a largest height H of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. Each of the interior walls 218a, 218b can have a wall height WH of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. In certain examples, the wall height WH of each of the interior walls 218a, 218b can be 50% or greater of the height H of the pet bed 200, such as 60% or greater, 75% or greater, 90% or greater, 95% or greater, 98% or greater, or 99% or greater. In some instances, the height H of the pet bed 200 can be substantially equal to the wall height WH of each of the interior walls 218a, 218b. Referring to FIGS. 4 and 5, in some instances (e.g., such as when the wall height WH of each of the interior walls 218a, 218b is less than the height H of the pet bed 200), the connection between the interior walls 218a, 218b and the upper portion 210 of the exterior cover 202 can cause grooves or creases 220a, 220b in the upper portion 210 of the exterior cover 202. Referring to FIG. 5, the connection between the interior walls 218a, 218b and the lower portion 212 of the exterior cover can cause grooves or creases 222a, 222b in the lower portion 212 of the exterior cover 202. In various instances, the wall height WH of a first interior wall 218a is substantially equal to the wall height WH of the other interior wall 218b. In other examples, the wall heights of the interior walls 218a, 218b can be different. The positioning of the interior wall 218 in the interior of the pet bed 200 can stabilize the pet bed 200 and cause the pet bed 200 to have a desired height.

Referring to FIG. 5, the interior wall 218a, 218b can separate the interior 208 of the pet bed 200 into a first filling chamber 224, a second filling chamber 225, and a third filling chamber 226. First filling material 228 can be disposed in the first filling chamber 224, second filling material 229 can be disposed in the second filling chamber 225, and third filling material 230 can be disposed in the third filling chamber 226. The filling material 228-230 can be, for example, fiberfill, foam, spunbond fiber, cotton shoddy, hemp, or any other suitable type of filling material for a pet bed. In some instances, the filling material 228-230 can include deodorizers and/or attractants, including, but not limited to Zeolite. The filling material 228-230 can be configured to provide any suitable hardness or firmness to the pet bed 200, where the type of filling material being used can affect the hardness or firmness of the pet bed 200. In some examples, the filling material 228-230 in one or more of the chambers 224-226 can be different than the filling material 228-230 in one or more of the other chambers 224-226 such that different portions of the pet bed 200 can have a different hardness or firmness. The first filling chamber 224 can have a width W1 of between about 5 inches and about 50 inches (such as between about 5 inches and about 40 inches, such as between about 5 inches and about 25 inches, such as between about 5 inches and about 20 inches, such as between about 5 inches and about 15 inches, such as about 9 inches), the second filling chamber 225 can have a width W2 of between about 5 inches and about 50 inches (such as between about 5 inches and about 40 inches, such as between about 5 inches and about 25 inches, such as between about 5 inches and about 20 inches, such as between about 5 inches and about 15 inches, such as about 9 inches), and the third filling chamber 226 can have a width W3 of between about 5 inches and about 50 inches (such as between about 5 inches and about 40 inches, such as between about 5 inches and about 25 inches, such as between about 5 inches and about 20 inches, such as between about 5 inches and about 15 inches, such as about 9 inches). In some instances, the widths W1-W3 are substantially equal. In other examples, at least one of the widths W1-W3 can be different than the others.

The interior walls 218a, 218b are configured to prevent the filling material 228-230 from moving from the corresponding filling chamber 224-226 into another filling chamber 224-226. This is advantageous because it prevents the pet bed 200 from becoming uneven due to movement of the filling material 228-230 into the other filling chambers 224-226. That is, with typical pet beds, a pet may be situated on one side of the pet bed and provide a force to the pet bed that causes the filling material on that side of the pet bed to move to the other side of the pet bed such that the pet bed is uneven. In these situations, the pet bed may remain uneven when the pet is no longer using the pet bed. However, the interior walls 218a, 218b are configured to prevent this type of movement of the filling material, which prevents the pet bed 200 from becoming uneven. Each of the interior walls 218a, 218b can have a thickness (not shown) of between about 0.2 mm and about 1 mm. The interior walls 218a, 218b can be made of, for example, polyester, cotton, rayon, polypropylene, taffeta, any combination thereof, or any other suitable material.

The exterior cover 202 can include an opening (not shown) that is movable between an open position and a closed position, where the opening allows a user to access the interior 208 of the pet bed 200 when the opening is in the open position. The pet bed 200 can include a fastener (e.g., a zip fastener, button(s), snap fasteners, hook and loop fasteners, etc.) that allows for a user to move the opening between the open and closed positions. The opening and fastener can take any suitable form and be disposed at any location on the exterior cover, such as, for example, any form and at any location described in the present application.

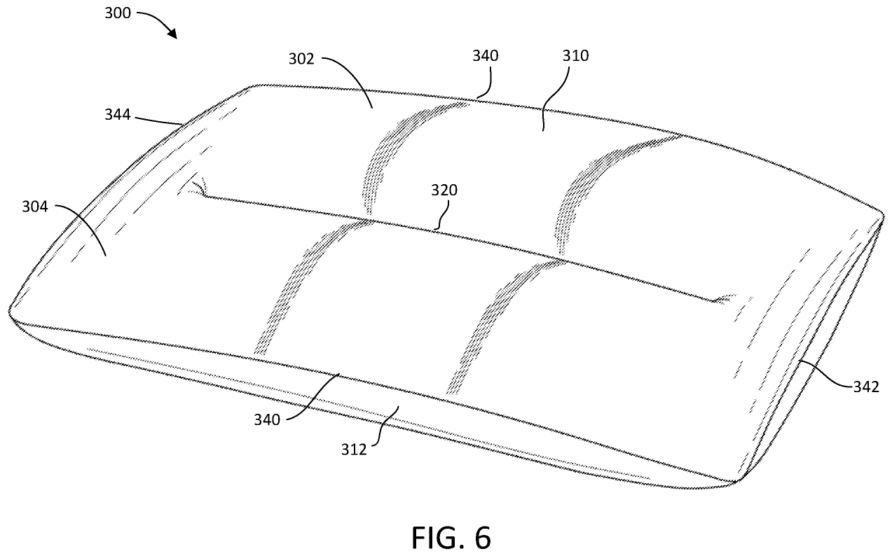

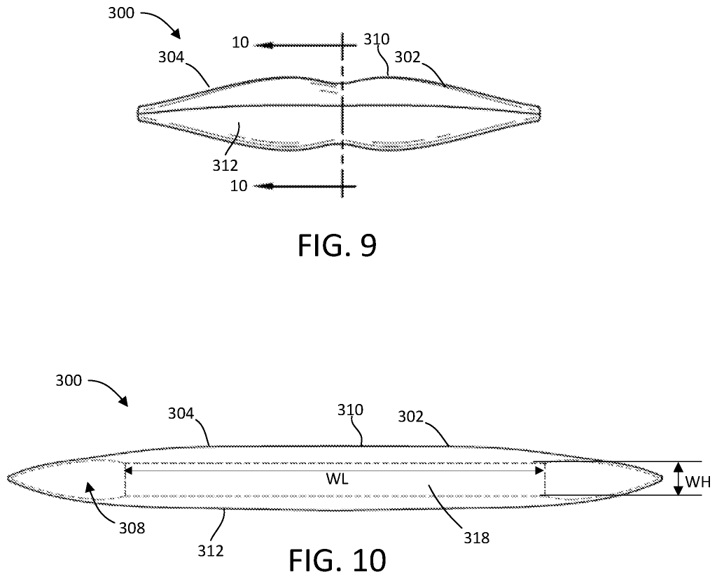

FIGS. 6-12 illustrate an example of a pet bed 300 that include an exterior cover 302 having an exterior surface 304 for being directly engaged by a pet. Referring to FIGS. 8 and 10, the exterior cover 302 further has an interior surface 306 that defines an interior 308 of the pet bed 300. The exterior cover 302 can have an upper portion 310 and a lower portion 312. Referring to FIG. 6, in the illustrated example, the upper portion 310 can be directly connected to the lower portion 312 at one or more of the side edges 340, at front edges 342, and at rear edges 344 of each of the upper and lower portions 310, 312. These direct connections can be, for example, a sewn connection, an adhesive connection, by the upper and lower portions 310, 312 being integral to each other, or by any other suitable connection. In other examples, the pet bed 300 can be gusseted such that side surfaces are connected to and extend between the upper portion 310 and the lower portion 312.

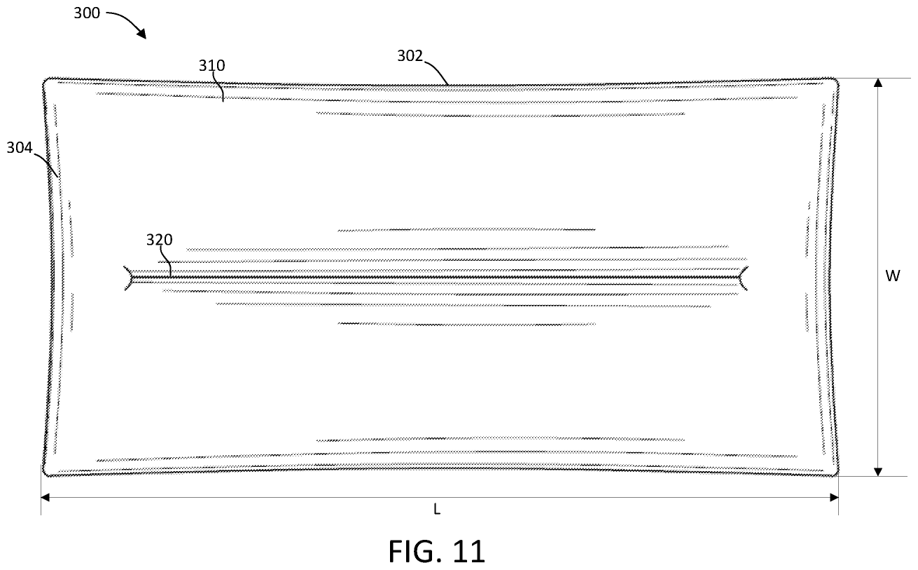

Referring to FIG. 11, the exterior cover 302 can have a length L that is between about 10 inches and about 100 inches (such as between about 20 inches and about 80 inches, such as between about 20 inches and about 60 inches, such as between about 20 inches and about 50 inches, such as between about 30 inches and about 40 inches, such as about 36 inches), and the exterior cover 302 can have a width W that is between about 10 inches and about 100 inches (such as between about 10 inches and about 80 inches, such as between about 10 inches and about 60 inches, such as between about 20 inches and about 50 inches, such as between about 20 inches and about 30 inches, such as about 27 inches). The exterior cover 302 can be made of, for example, polyester, cotton, rayon, polypropylene, taffeta, or any other suitable material. While the illustrated example shows the pet bed 300 having a rectangular shape, it should be understood that the pet bed 300 can have any other suitable type of shape for a pet bed. In some examples, the top portion 310 of the exterior cover 302 is made of a first material and the lower portion 312 of the exterior cover 302 is made from a second material that is different from the first material, where the first and second materials can be any of the materials listed in the present application for the exterior cover 302 or any other suitable material.

Referring to FIGS. 8 and 10, the pet bed 300 further includes an interior wall 318 that is connected to the upper and lower portions 310, 312 of the exterior cover 302. The interior wall 318 can be fixedly connected to the upper and lower portions 310, 312, such as, for example, by a sewn connection, an adhesive connection, or any other suitable type of fixed connection. In some examples, the interior wall 318 can be removably connected to the upper and lower portions 310, 312, such as, for example, by a buttoned connection, a snap fit connection, any other male/female type connection, a hook and loop connection, or any other type of removable connection. In some instances, the interior wall 318 can be fixedly connected to one of the upper and lower portions 310, 312 and removably connected to the other of the upper and lower portions 310, 312.

Referring to FIG. 10, the interior wall 318 can have a wall length WL of between about 8 inches and about 100 inches, such as between about 10 inches and about 90 inches, such as between about 15 inches and about 75 inches, such as between about 20 inches and about 60 inches, such as between about 20 inches and about 50 inches, such as between about 20 inches and about 40 inches, such as about 30 inches. In certain examples, the wall length WL of the interior wall 318 can be 50% or greater of the length L (FIG. 11) of the exterior cover 302, such as 60% or greater, 75% or greater, 80% or greater, 83% or greater, 90% or greater, 95% or greater, 98% or greater, or 99% or greater. In some instances, the length L of the exterior cover 302 can be substantially equal to the wall length WL of the interior wall 318. While the illustrated example shows the interior wall 318 being a single member that extends the wall length WL, in other examples, the interior wall 318 can include two or more members that combine to extend the wall length WL.

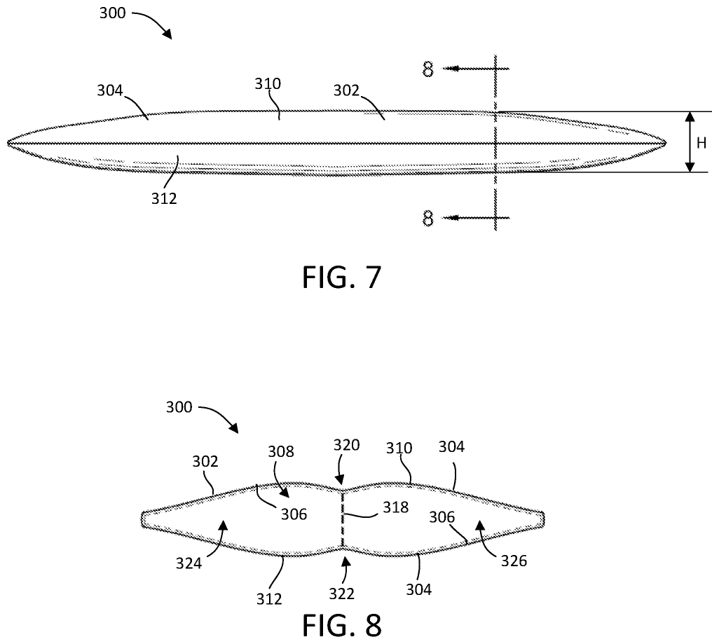

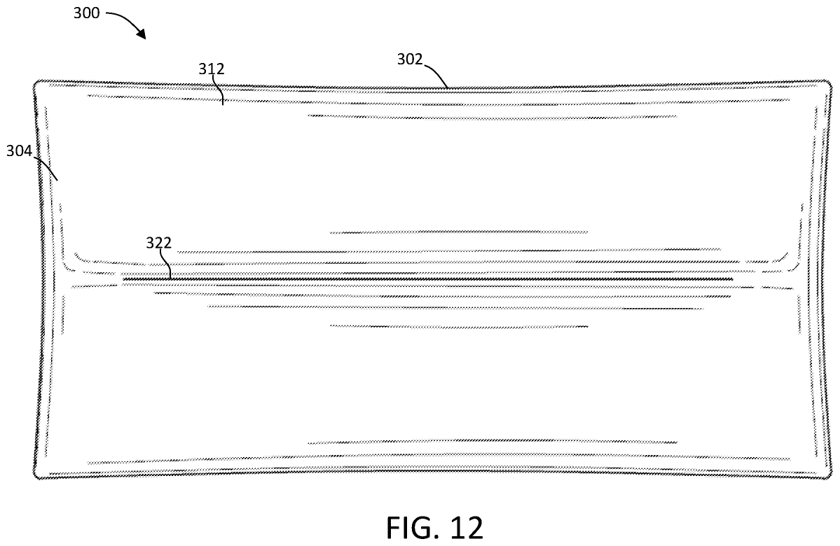

Referring to FIG. 7, the pet bed 300 can have a largest height H of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. Referring to FIG. 10, the interior wall 318 can have a wall height WH of between about 1 inch and about 20 inches, such as between about 1 inch and about 15 inches, such as between about 1 inch and about 12 inches, such as between about 1 inch and about 8 inches, such as between about 2 inches and about 6 inches, such as about 4 inches. In certain examples, the wall height WH of the interior wall 318 can be 50% or greater of the height H of the pet bed 300, such as 60% or greater, 75% or greater, 90% or greater, 95% or greater, 98% or greater, or 99% or greater. In some instances, the height H of the pet bed 300 can be substantially equal to the wall height WH of the interior wall 318. Referring to FIGS. 6 and 8, in some instances (e.g., such as when the wall height WH is less than the height H), the connection between the interior wall 318 and the upper portion 310 of the exterior cover 302 can cause a groove or crease 320 in the upper portion 310 of the exterior cover 302. Referring to FIGS. 8 and 12, the connection between the interior wall 318 and the lower portion 312 of the exterior cover 302 can cause a groove or crease 322 in the lower portion 312 of the exterior cover 302. The positioning of the interior wall 318 in the interior of the pet bed 300 can stabilize the pet bed 300 and cause the pet bed 300 to have a desired height.

Referring to FIG. 8, the interior wall 318 can separate the interior 308 of the pet bed 300 into a first filling chamber 324 and a second filling chamber 326, where first filling material (not shown) can be disposed in the first filling chamber 324 and second filling material (not shown) can be disposed in the second filling chamber 326. The first and second filling material can be, for example, fiberfill, foam, or any other suitable type of filling material for a pet bed. The first filling chamber 324 can have a width W1 of between about 5 inches and about 50 inches (such as between about 5 inches and about 40 inches, such as between about 5 inches and about 25 inches, such as between about 5 inches and about 20 inches, such as between about 10 inches and about 15 inches, such as about 13.5 inches), and the second filling chamber 326 can have a width W2 of between about 5 inches and about 50 inches (such as between about 5 inches and about 40 inches, such as between about 5 inches and about 25 inches, such as between about 5 inches and about 20 inches, such as between about 10 inches and about 15 inches, such as about 13.5 inches). In some instances, the width W1 and the width W2 are substantially equal. In other examples, the width W1 and the width W2 can be different.

The interior wall 318 is configured to prevent the filling material from moving from one filling chamber 324, 326 and into the other filling chamber 324, 326. This is advantageous because it prevents the pet bed 300 from becoming uneven due to movement of the filling material into the other filling chambers 324, 326. That is, with typical pet beds, a pet may be situated on one side of the pet bed and provide a force to the pet bed that causes the filling material on that side of the pet bed to move to the other side of the pet bed such that the pet bed is uneven. In these situations, the pet bed may remain uneven when the pet is no longer using the pet bed. However, the interior wall 318 is configured to prevent this type of movement of the filling material, which prevents the pet bed 300 from becoming uneven. The interior wall 318 can have a thickness (not shown) of between about 0.2 mm and about 1 mm. The interior wall 318 can be made of, for example, polyester, cotton, rayon, polypropylene, taffeta, any combination thereof, or any other suitable material.

The exterior cover 302 can include an opening (not shown) that is movable between an open position and a closed position, where the opening allows a user to access the interior 308 of the pet bed 300 when the opening is in the open position. The pet bed 300 can include a fastener (e.g., a zip fastener, button(s), snap fasteners, hook and loop fasteners, etc.) that allows for a user to move the opening between the open and closed positions. The opening and fastener can take any suitable form and be disposed at any location on the exterior cover, such as, for example, any form and at any location described in the present application.

While the various examples described above show a pet bed having a single interior wall that separates the interior of the pet bed into two filling chambers or a pet bed having two interior walls that separate the interior of the pet bed into three filling chambers, it should be understood that any of the pet beds described in the present application can include any suitable number of interior walls that separates the interiors of the pet beds into any suitable number of filling chambers. For example, any of the pet beds described herein can have one or more interior walls, two or more interior walls, three or more interior walls, four or more interior walls, etc. In addition, the interior wall(s) can separate the interior of the pet bed into two or more filling chambers, three or more filling chambers, four or more filling chambers, five or more filling chambers, etc.

Also, while the pet beds described herein illustrate the interior wall(s) and the corresponding filling chambers extending along the length of the pet bed, in other instances, the interior wall(s) and corresponding filling chambers can extend along a width of the pet beds. In some instances, a pet bed can include one or more interior walls that extend along the length of the pet bed and one or more additional interior walls that extend along the width of the pet bed.

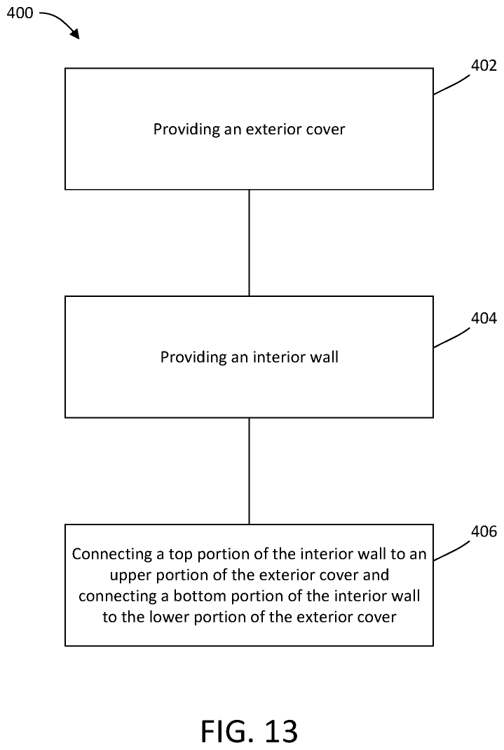

An example of a method 400 for manufacturing a pet bed is shown in FIG. 13, where the pet bed does not include an interior liner. That is, the pet bed includes an exterior cover and an interior wall, where filling material can be added directly into the exterior cover to provide a cushioning material for a pet that is using the pet bed, rather than the filling material being inside an interior liner that is positioned within the exterior cover. The method 400 includes providing an exterior cover (as shown at box 402) and providing an interior wall (as shown at box 404). Providing the exterior cover can include manufacturing the exterior cover or obtaining the exterior cover from a third party, and providing the interior wall can include manufacturing the interior wall or obtaining the interior wall from a third party. The exterior cover can take any suitable form, such as, for example, any form described in the present application. The interior wall can take any suitable form, such as, for example, any form described in the present application. The method 400 further includes connecting a top portion of the interior wall to an upper portion of the exterior cover and connecting a bottom portion of the interior wall to a bottom portion of the exterior cover (as shown at box 406). The interior wall can be fixedly connected to the exterior cover or removably connected to the exterior cover. The interior wall can be connected to the exterior cover by any suitable means, such as, for example, any means described in the present application.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A pet bed, comprising:
an exterior cover having an interior surface that defines an interior of the pet bed, wherein the exterior cover has an upper portion and a lower portion;
an interior wall connected to both the upper portion and the lower portion of the exterior cover, wherein the interior wall is disposed in the interior of the pet bed;
wherein the interior wall separates the interior of the pet bed into a first filling chamber and a second filling chamber;
wherein the interior wall is configured to prevent a first portion of filling material disposed in the first filling chamber from moving into the second filling chamber when a pet is providing a force to the pet bed; and
wherein the interior wall is configured to prevent a second portion of filling material disposed in the second filling chamber from moving into the first filling chamber when a pet is providing a force to the pet bed.

2. The pet bed according to claim 1, wherein the interior wall is connected to the upper portion and the lower portion of the exterior cover by a sewn connection.

3. The pet bed according to claim 1, wherein the interior wall is removably connected to the upper portion and the lower portion of the exterior cover.

4. The pet bed according to claim 3, wherein the interior wall is connected to the upper portion and the lower portion of the interior wall by a buttoned connection.

5. The pet bed according to claim 1, wherein the exterior cover has a gusseted side edge.

6. The pet bed according to claim 5, wherein the pet bed has a height of between about 1 inch and about 20 inches.

7. The pet bed according to claim 1, wherein the upper portion and the lower portion of the exterior cover are directly connected at one or more edges.

8. The pet bed according to claim 7, wherein the upper portion and the lower portion of the exterior cover are directly connected at the one or more edges by a sewn connection.

9. The pet bed according to claim 7, wherein the upper portion and the lower portion of the exterior cover are integral to each other.

10. The pet bed according to claim 7, wherein the pet bed has a height of between about 1 inch and about 20 inches.

11. The pet bed according to claim 1, wherein the interior wall has a height of between about 1 inch and about 20 inches.

12. The pet bed according to claim 1, wherein the interior wall has a wall length that is equal to 50% or greater of a length of the exterior cover.

13. The pet bed according to claim 1, wherein the interior wall has a length of between about 8 inches and about 100 inches.

14. The pet bed according to claim 1, wherein a first width of the first filling chamber is equal to a second width of the second filling chamber.

15. The pet bed according to claim 1, wherein the interior wall is positioned at a center of the exterior cover along a width of the exterior cover.

16. The pet bed according to claim 1, wherein the interior wall is made of at least one of polyester, cotton, rayon, polypropylene, and taffeta.

17. The pet bed according to claim 1, further comprising a filling material disposed within the interior of the pet bed, wherein the filling material comprises the first filling material and the second filling material.

18. The pet bed according to claim 1, further comprising a second interior wall connected to both the upper portion and the lower portion of the exterior cover, wherein the second interior wall is parallel to the interior wall, and wherein the second interior wall separates a portion of the interior of the pet bed into a third filling chamber and the first filling chamber.

19. The pet bed according to claim 18, wherein a first width of the first filling chamber, a second width of the second filling chamber, and a third width of the third filling chamber are equal to each other.

20. A method of manufacturing a pet bed, the method comprising:
providing an exterior cover, the exterior cover having an upper portion and a lower portion that define an interior of the pet bed;
providing an interior wall having a top portion and a bottom portion; and
connecting the top portion of the interior wall to the upper portion of the exterior cover and the bottom portion of the interior wall to the lower portion of the exterior cover, wherein the connected interior wall separates the interior of the pet bed into a first filling chamber and a second filling chamber.

21. The method according to claim 20, wherein the exterior cover includes side portions that are positioned between the upper portion and the lower portion such that the pet bed is a gusseted pet bed.

22. The method according to claim 20, wherein the upper portion of the exterior cover and the lower portion of the exterior cover are directly connected.

23. The method according to claim 21, wherein the interior wall is connected to the upper portion and the lower portion of the exterior cover by a sewn connection.

24. The method according to claim 20, wherein the interior wall is removably connected to the upper portion and the lower portion of the exterior cover.

25. The method according to claim 24, wherein the interior wall is connected to the upper portion and the lower portion of the interior wall by a buttoned connection.

26. The method according to claim 20, wherein the interior wall has a wall length that is equal to 50% or greater of a length of the exterior cover.

27. The method according to claim 20, wherein the interior wall has a length of between about 8 inches and about 100 inches.

28. The method according to claim 20, wherein a first width of the first filling chamber is equal to a second width of the second filling chamber.

29. The method according to claim 20, wherein the interior wall is positioned at a center of the exterior cover along the width of the exterior cover.

30. The method according to claim 20, further comprising inserting a filling material into the first filling chamber and the second filling chamber.

31. The method according to claim 20, further comprising connecting a second interior wall connected to both the upper portion and the lower portion of the exterior cover, wherein the second interior wall separates a second portion of the interior of the pet bed into a third filling chamber and the first filling chamber.

32. The method according to claim 31, wherein a first width of the first filling chamber, a second width of the second filling chamber, and a third width of the third filling chamber are equal to each other.
